(19) United States
(12) Patent Application Publication
(10) Pub. No.: US 2014/0177483 A1
(43) Pub. Date: Jun. 26, 2014

(54) REDUCING INTERFERENCE IN A WIRELESS NETWORK

(71) Applicants: William John Jones, Chippenham (GB); Timothy Wilkinson, Bristol (GB)

(72) Inventors: William John Jones, Chippenham (GB); Timothy Wilkinson, Bristol (GB)

(73) Assignee: INTELLECTUAL VENTURES HOLDING 81 LLC, Las Vegas, NV (US)

(21) Appl. No.: 14/118,795

(22) PCT Filed: May 1, 2012
(86) PCT No.: PCT/EP2012/057953

§ 371 Date: Jan. 28, 2014

(30) Foreign Application Priority Data
May 25, 2011 (GB) 1108743.4

(51) Int. Cl. H04W 72/02; H04L 5/14; H04W 72/00; H04W 24/08

(52) U.S. Cl. CPC H04W 72/02; H04W 24/08; H04L 5/14; H04W 72/005
USPC 370/278; 370/329

(57) ABSTRACT

Managing interference in a wireless network is disclosed. A signal quality level may be determined of a downlink signal on a downlink channel associated with an uplink channel of a first network element. Determination of an interference potential between the first network element and the second network element from the signal quality level may be performed. Adapting a network parameter associated with the downlink channel in response to the determined interference potential may be performed.

### FIELD OF INVENTION

The field of this invention relates to an apparatus and method for reducing interference in a wireless communication system. In particular, the field of the invention relates to a wireless network element recognizing potential interference and adapting its communication (network parameter) characteristics or resources, in order to reduce potential interference, for example in a 3^{rd} Generation Partnership Project (3GPP™) Long Term Evolution (LTE) cellular communication system.

### BACKGROUND OF THE INVENTION

During the 1980s and 1990s, second generation (2G) cellular communication systems were implemented to provide mobile phone communications. 3rd generation (3G) cellular communication systems have since been widely installed to further enhance the communication services that may be provided to mobile phone users. The most widely adopted 3^{rd} generation communication systems are based on Code Division Multiple Access (CDMA) and Frequency Division Duplex (FDD) or Time Division Duplex (TDD) technology.

Historically, spectrum allocations for mobile phone and mobile radio communications systems have been either paired and thereby intended for FDD operation, or unpaired and thereby intended for TDD operation. FDD means that the transmitter and receiver, in a given wireless subscriber communication device or base station, operate at different carrier frequencies. Typically, a wireless subscriber unit is ‘connected’ to one wireless serving communication unit, i.e. a base station serving one communication cell. Uplink (UL) and downlink (DL) frequencies/sub-bands are separated by a (paired) frequency offset. FDD can be efficient in the case of symmetric traffic, such as voice communication, and as a consequence many historical spectral allocations comprise sets of paired frequencies for FDD operation.

In TDD systems, the same carrier frequency is used for both uplink (UL) transmissions, i.e. transmissions from the mobile wireless communication unit (often referred to as wireless subscriber communication unit) to the communication infrastructure via a wireless serving base station and downlink (DL) transmissions, i.e. transmissions from the communication infrastructure to the mobile wireless communication unit via a serving base station. In TDD, the carrier frequency is subdivided in the time domain into a series of time slots and/or frames. The single carrier frequency is assigned to uplink transmissions during some time slots and to downlink transmissions during other time slots. In FDD systems, a pair of separated carrier frequencies is used for respective uplink and downlink transmissions to avoid interference there between. An example of communication systems using these principles is the Universal Mobile Telecommunication System (UMTS™).

A recent development in 3G communications is the long term evolution (LTE) cellular communication standard, sometimes referred to as 4^{th} generation (4G) systems, which are compliant with 3GPP™ standards. These 4G systems will be deployed in existing spectral allocations owned by Network Operators and new spectral allocations that are yet to be licensed. Irrespective of whether these LTE spectral allocations use existing 2G and 3G allocations being re-farmed for fourth generation (4G) systems, or new spectral allocations for existing mobile communications, they will be primarily paired spectrum for FDD operation.

Recently, unpaired spectrum in 3G and 4G systems has been targeted for additional services, for example downlink only broadcast-like technologies, such as integrated mobile broadcast (1MB) communications within the universal mobile telecommunication system (UMTS™), and enhanced multicast broadcast multimedia service (eMBMS) as part of the Long Term Evolution (LTE) standard. It is envisaged that broadcast communications will continue to be popular for many years to come. Thus, more combinations of paired and unpaired spectrum will be licensed for 4G systems, such as LTE. In these allocations, the unpaired spectrum is often uncomfortably close to the paired spectrum, such that there is the potential of interference between downlink communications from a broadcast site in the unpaired spectrum and adjacent uplink communications in the paired spectrum.

Referring now to FIG. 1, a pictorial example 100 of the aforementioned potential interference (sometimes referred to as ‘co-existence’) problem is illustrated with regard to transmit power or attenuation 105 versus frequency 110. A downlink (DL) (i.e. a base station transmitting to a wireless subscriber communication unit) interfering transmit spectrum 115 is shown as being adjacent an uplink (UL) (i.e. a wireless subscriber communication unit transmitting to a base station) receive band 120. DL out-of-band adjacent channel transmissions can be filtered 115 to an acceptably low power level by the transmit filter. Furthermore, if the in-band adjacent channel transmissions are not filtered to an acceptable level by the victim receiver 125, it is known that the interfering transmitter in-band power may be adjusted (i.e. lowered) 130 to create less interference to the receiver, i.e. the transmit in-band signal power may be reduced, such that there is less unwanted signal that is passed through the victim receiver filter.

Thus, FIG. 1 illustrates that there are two aspects to the potential interference. The first aspect, i.e. potential adjacent channel of the interferer, may be controlled by the interferer through filtering. The second aspect of the potential interference is with the in-band power of the interferer blocking the victim's receiver. This second aspect of potential interference can only be controlled by improved filtering on the victim, which is typically not feasible as it likely requires adjustment of a different Network Operator's equipment. Hence, a more acceptable, flexible solution is desired.

Previously, with bi-directional communication systems deployed in both paired and unpaired spectrum, solving such co-existence problems has been difficult, as the system designer has to compromise between cost increases and/or performance impact. This problem predominantly exists where a broadcast base station (referred to as a NodeB in 3G and 4G parlance) transmitter may be substantially co-located with a bi-directional (bi-directional) NodeB transceiver, or where the broadcast NodeB transmitter and bi-directional (bi-directional) NodeB transceiver are located on adjacent sites, such as buildings where their respective antennas may be directed towards each other. Broadcast systems using a SFN (Single Frequency Network) offer great flexibility in how they are deployed, as the same broadcast content is transmitted simultaneously from all cell sites and the only goal of the Network Operator is to flood the coverage area of the communication cell with power. This means that a broadcast system can be regarded as having a secondary status and, thus, be readily adjusted to ensure that there is no interference into a so-called primary bi-directional communication system.

Consequently, current techniques are suboptimal. Hence, an improved mechanism to address the potential interference problem is desired that may benefit from the increased design and feature flexibility available from recent cellular network developments.

### SUMMARY OF THE INVENTION

Accordingly, the invention seeks to mitigate, alleviate or eliminate one or more of the abovementioned disadvantages, either singly or in any combination.

According to aspects of the invention, there is provided, a wireless network element, an integrated circuit, a method for reducing interference and a computer program product adapted or configured to implement the concepts herein described, as detailed in the appended Claims.

These and other aspects, features and advantages of the invention will be apparent from, and elucidated with reference to, the example embodiment(s) described hereinafter.

### BRIEF DESCRIPTION OF THE DRAWINGS

Embodiments of the invention will be described, by way of example only, with reference to the accompanying drawings, in which:

FIG. 1 illustrates a known adjacent channel interference problem.

FIG. 2 illustrates a 3GPP™ LTE cellular communication system adapted in accordance with some example embodiments of the present invention.

FIG. 3 illustrates a simplified example of a wireless network element, such as an eNodeB base station, adapted in accordance with some example embodiments of the invention.

FIG. 4 illustrates a more detailed example of a wireless network element, such as an eNodeB base station, adapted in accordance with some example embodiments of the invention.

FIG. 5 illustrates a HD FDD and HD TDD framing/timing structure in accordance with some example embodiments of the invention.

FIG. 6 illustrates an example of a flowchart to reduce interference from the interferer to the victim communications in accordance with some example embodiments of the invention.

FIG. 7 illustrates a simple example of a typical computing system that may be employed to implement signal processing functionality in embodiments of the invention.

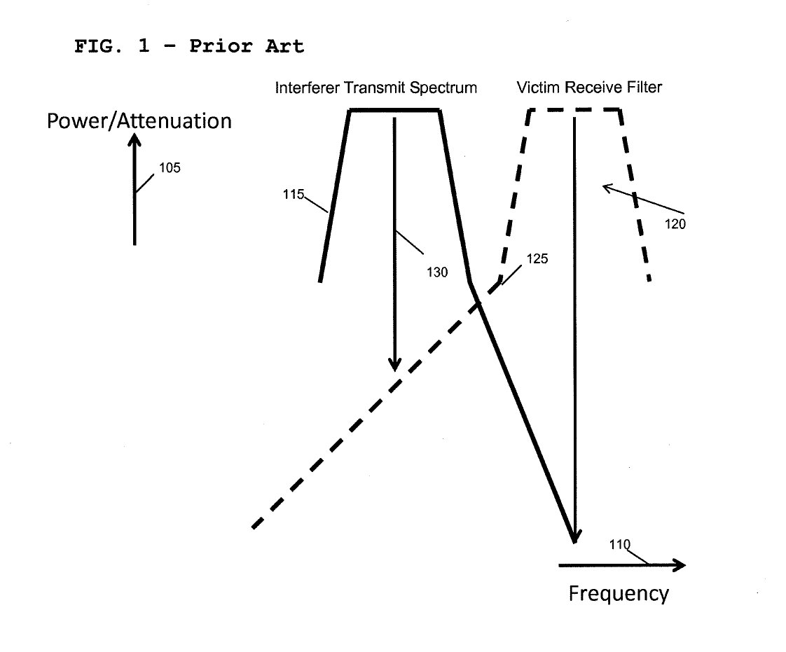

### DETAILED DESCRIPTION OF EMBODIMENTS OF THE INVENTION

The following description focuses on embodiments of the invention applicable to a UMTS™ (Universal Mobile Telecommunication System) cellular communication system and in particular to a UMTS™ Terrestrial Radio Access Network (UTRAN) operating in any paired or unpaired spectrum within a 3rd generation partnership project (3GPP™) system. Furthermore, the following description focuses on embodiments of the invention applicable to supporting broadcast transmissions in a 3G or 4G system, for example when employing a SFN technique. However, it will be appreciated that the invention is not limited to this particular cellular communication system, but may be applied to any wireless communication system that may suffer from potential adjacent channel or inter-cell interference. However, in other examples, the inventive concept may be applied to adjacent channel TDD systems, for example in un-synchronised systems or when using uncoordinated switching points (UL/DL) within the frame and/or when performing joint scheduling between frequency carriers.

To address or alleviate the aforementioned second aspect of potential interference, e.g. in-band power of the interferer blocking the victim's receiver, the in-band power of the interferer may be adjusted. Example embodiments of the invention propose determining whether to perform any adjustment of a network parameter or operating characteristic based on potential interference between at least two wireless network elements of different systems. This determination may be performed by measuring a coupling loss between the two wireless network elements, for example by determining path loss from a broadcast transmitter to a receiver of a bi-directional system, thereby determining whether interference is likely. In response to determining that interference is likely, a determination as to how much interference may be caused may be performed, so that appropriate action can be taken to avoid or mitigate or minimise the interference. Furthermore, example embodiments of the present invention propose a method and apparatus for performing measurements to be able to determine the appropriate adjustment to make to reduce potential interference.

Thus, example embodiments of the present invention have recognised that interference potential can be assessed by measuring the coupling loss through a power measurement on the downlink channel of an adjacent victim system associated with the uplink channel at risk of interference, and in some instances applying a reciprocity theorem to such a determination.

Several adjustments of the respective network parameters are possible, such as at least one of: transmit power, antenna azimuth, antenna tilt, polarisation of an antenna, transmission polarisation, in order to limit the RF leakage of the broadcast transmitter into the bi-directional receiver. These adjustments can be used to increase the coupling loss between the interfering broadcast transmitter and the victim bi-directional base station comprising an uplink receiver. Such adjustments would typically be made on the broadcast system, as it is a secondary service and the same content is transmitted from all broadcast cell sites within a specific service area. Thus, such adjustments may enable a reduction or adjustment in the coverage footprint of one site to be compensated for by that of an adjacent site.

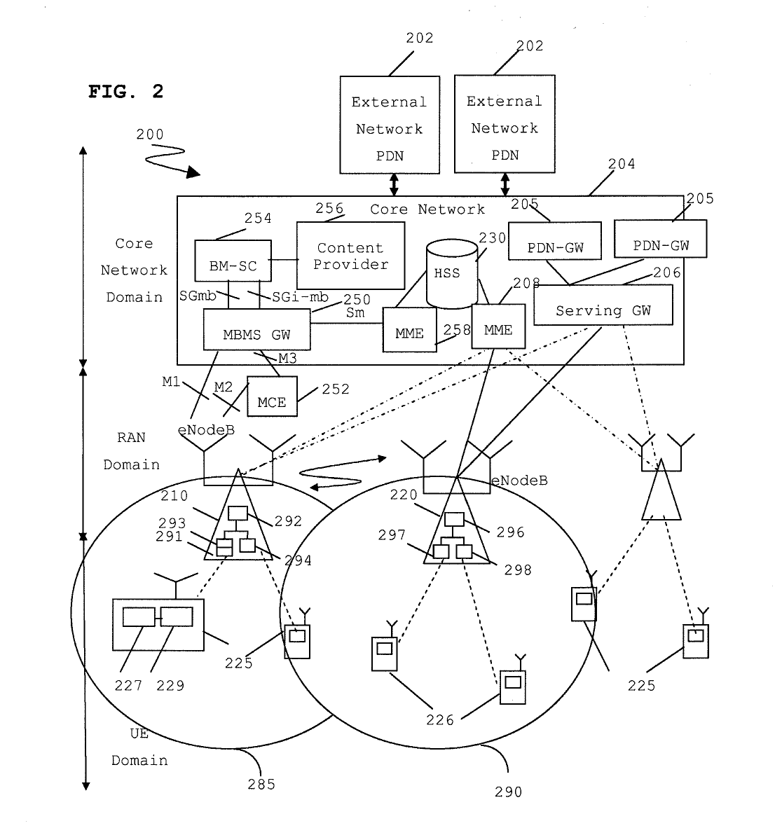

Referring now to FIG. 2, a wireless communication system 200 is shown in outline, in accordance with one example embodiment of the invention. In this example embodiment, the wireless communication system 200 is compliant with, and contains network elements capable of operating over, a universal mobile telecommunication system (UMTS™) air-interface. In particular, the embodiment relates to a system's architecture for an Evolved-UTRAN (E-UTRAN) wireless communication system, which is currently under discussion in the third Generation Partnership Project (3GPP™) specification for long term evolution (LTE), and described in the 3GPP TS 36.xxx series of specifications.

The architecture consists of radio access network (RAN) and core network (CN) elements, with the core network 204 being coupled to external networks 202 named Packet Data Networks (PDNs), such as the Internet or a corporate network. The CN 204 has three main components: a serving GW 206, the PDN GW (PGW) 205 and a first mobility management entity (MME) 208. The serving-GW 206 controls the U-plane (user-plane) communication. The PDN-GW 205 controls access to the appropriate external network (e.g. PDN). The first MME 208 controls the c-plane (control plane) communication, where the user mobility, paging initiation for idle mode UEs, bearer establishment, and QoS support for the default bearer are handled by the MME 208.

The main component of the RAN is an eNodeB (an evolved NodeB) which is connected to the CN 204 via S1 interface and connected to the UEs 225 via an Uu interface. A wireless communication system will typically have a large number of such infrastructure elements where, for clarity purposes, only a limited number are shown in FIG. 2. The eNodeBs 210, 220 control and manage the radio resource related functions for a plurality of wireless subscriber communication units/terminals (or user equipment (UE) 225 in UMTS™ nomenclature).

In the example architecture of FIG. 2 a first eNodeB 210 is arranged to broadcast data to UEs 225 within the broadcast coverage area, and a second eNodeB 220 is arranged to perform bidirectional communication with UEs 226 within the bi-directional coverage area. As shown, the broadcast and bi-directional coverage areas overlap. In other example embodiments, the coverage areas may overlap to a lesser or greater extent or one coverage area may reside fully within the other coverage area. In other example embodiments the first and second eNodeBs may be substantially co-located and therefore, in some instances support the same or similar effective coverage areas/range.

In a first example scenario, supporting standard bi-directional communications, the series of eNodeBs 210, 220 typically perform lower layer processing for the network, performing such functions as Medium Access Control (MAC), formatting blocks of data for transmission and physically transmitting the transport blocks to UEs 225, 226. In addition to these functions, the eNodeBs 210, 220 respond to demands for resource from the UEs 225, 226 by allocating resource in either, or both, uplink (UL) and/or downlink (DL) time slots for individual UEs 225 to use. Each of the UEs 225, 226 comprise a transceiver unit 227 operably coupled to signal processing logic 229 (with one UE illustrated in such detail for clarity purposes only) and communicate with the eNodeB 210 supporting communication in its/their respective location area.

In a second example scenario, supporting for example broadcast (MBMS/eMBMS) communications, where one or more of the series of eNodeBs 210, 220 is used for broadcast and all of its resources are dedicated to this mode of operation, there is no ‘allocation of resources’ and no UL communication path. 3GPP™, UMTS™ and LTE, allow for both in-band and dedicated broadcast, with in-band communication mixing broadcast and bi-directional on the same radio frequency carrier. Here, the CN 204 comprises a broadcast media service centre (BM-SC) 254 that, in one example, is coupled to, in order to receive broadcast content from a content provider 256. The CN 204 also comprises, in this example, an evolved multicast broadcast multimedia server (MBMS) gateway (GW) 250 coupled to the BM-SC 254 and coupled to a second mobility management entity (MME) 258 via an Sm interface. The second MME 258 manages session control of MBMS bearers and is operably coupled to the home subscriber service (HSS) database 230 storing subscriber communication unit (UE) related information. The MBMS gateway 250 acts as a mobility anchor point and provides IP multicast distribution of the MBMS user plane data to the eNodeBs. The MBMS gateway 250 receives MBMS content via the Broadcast Multicast Service Centre (BM-SC) 254 from one or more content providers 256. For control plane (CP) data, a MBMS coordination entity (MCE) 252 resides in the E-UTRAN between the MME 258 and the eNodeBs 210, 220. The MCE 252 manages the layer-2 configurations and the use of the radio resources for broadcast transmission. Thus, the MCE 252 is a RAN domain element and can be either a separate entity (as shown) or located at the eNodeB 210, 220. For user plane (UP) data, the BM-SC 254 is directly coupled to the eNodeBs 210, 220 via an M1 interface.

However, a problem with this second broadcast example scenario is that with in-band communication mixing broadcast and bi-directional on the same radio frequency carrier, it is not possible to freely adjust power, etc. in order to minimise interference as such an adjustment may adversely affect the bidirectional part of the eNodeB's functionality.

The system typically comprises many other UEs 225, 226 and eNodeBs 210, 220, which for clarity purposes are not shown.

As indicated above, in one example embodiment, first eNodeB 210 is configured as a broadcast transmitter, supporting multicast broadcast multimedia services (MBMS), or evolved MBMS (eMBMS) for an LTE system, to UEs 225 within its coverage range. The first (broadcast) eNodeB 210 comprises one or more wireless transceiver units 294 that is/are operably coupled to one or more signal processor modules 292. The one or more wireless transceiver units 294 of the first (broadcast) wireless network element (eNodeB 210) is arranged to receive a downlink signal from the second wireless network element on a downlink channel associated with an uplink channel of the second wireless network element. The first (broadcast) wireless network element (eNodeB 210) comprises logic 293 arranged to determine a signal quality level of the received downlink signal from the second (bi-directional) wireless network element. In some examples, the determination of the signal quality level of the received downlink signal may be based on a measured parameter of the received downlink signal. In some examples, the logic 293 may reside within the one or more signal processor modules 292 or may be operably coupled thereto. The logic 293 is also arranged to determine an interference potential between the first wireless network element (eNodeB 210) and the second wireless network element (eNodeB 220) from the determination of the signal quality level of the received downlink signal. In response thereto, the first (broadcast) wireless network element (eNodeB 210) comprises adapting logic 291 arranged to adapt a network parameter of the first wireless network element in response to the determining of the interference potential.

A second eNodeB 220 operates as a bi-directional transceiver, supporting bi-directional (e.g. voice and or data) communications to UEs 226 within its coverage range. The second eNodeB 220 also comprises one or more wireless transceiver units 297 that is/are operably coupled to one or more signal processor modules 296 and also communicates with the rest of the cell-based system infrastructure via an Lb interface, as defined in the UMTS™.

In some example embodiments, a simple receiver within the one or more wireless transceiver units 294 may be provided in the first eNodeB 210 (e.g. at the broadcast transmitter) coupled to one or more antenna port(s). The simple receiver may be tuned (or tuneable) to one or more downlink channels associated with the uplink channels on the adjacent site that is supported by the second eNodeB 220, interference from which may potentially affect the broadcast transmissions. In one example embodiment, the simple receiver may be operably coupled to signal quality determination logic 293. In one example, the signal quality determination logic 293 has the ability to measure the received power from this adjacent site. In this manner, the signal quality determination logic 293 may be arranged to determine an effect, e.g. with regard to a change in path loss measurement, before and after adjustment of one or more network parameters (such as at least one of: transmit power, antenna azimuth, antenna tilt, polarisation of an antenna, transmission polarisation, etc.) of the antenna array used by the broadcast transmitter.

In some example embodiments, the determination performed by the signal quality determination logic 293 may be used in conjunction with a typical minimum or known transmit power (beacon or otherwise) of this technology to calculate a minimum coupling loss between antenna ports on the broadcast system and bi-directional system. In this manner, the propagation loss from the bi-directional eNodeB transmitter may be measured at the simple receiver located in the first eNodeB (broadcast transmitter) in order to determine a ‘coupling loss’ between the two sites. A signal processing module 292 in the first eNodeB 210 may then apply the reciprocity theorem and thereby assume the same coupling loss (propagation loss) exists in the reverse direction. Thus, example embodiments of the invention propose a cognitive and responsible broadcast transmitter.

In some example embodiments, signal processing module 292 in the first eNodeB 210 may utilise the coupling loss measurement, in conjunction with a determined knowledge of the potential interference problem (such as information relating to one or more network characteristic or parameter of: broadcast transmitter power, blocking performance of the victim equipment, etc.), in order to determine whether (or not) interference was likely. If interference is likely, or indeed possible, the signal processing module 292 may determine that remedial action may assist in resolving or mitigating the potential interference problem. Consequently, in such a scenario, adapting logic 291 (which may form part of the signal processing module 292 in some example embodiments) may initiate a reduction in broadcast transmit power and/or increase in the coupling loss by other means, such as adjustment of antenna tilt or direction.

In some example embodiments, the measurement and monitoring of the first eNodeB 210 may be performed at system deployment and, in some instances, repeated on an ongoing basis to determine whether (or not) new sites or antennas have been deployed that may impact inter-site interference or whether (or not) new frequency channels had been activated, etc. In some example embodiments, such a system deployment or on-going measurement may be presented in a broadcast system element manager (EM) and one or more alarms may be raised if the coupling loss measurement went below a configurable threshold. In response to such an alarm, an automatic or manual adjustment of one or more network parameters may be effected, for example in response to an alarm notification. In this manner, the signal processing module 296 may be configured to automatically reduce transmit power or shut down the broadcast transmitter altogether.

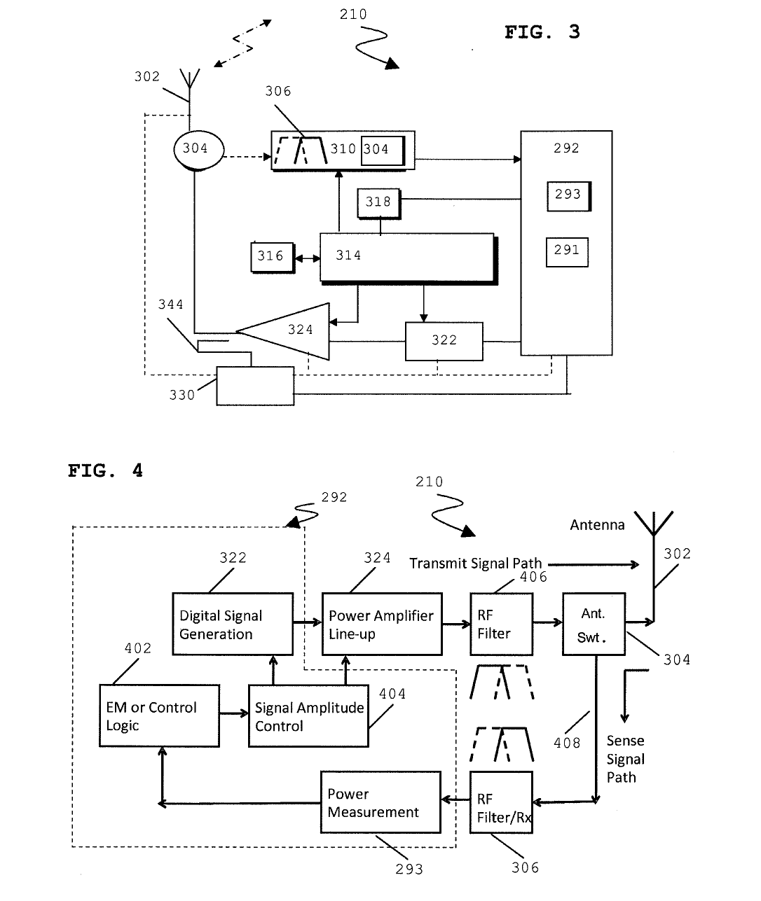

Referring now to FIG. 3, a block diagram of a wireless communication unit, such as first (broadcast) eNodeB 210, adapted in accordance with some example embodiments of the invention, is shown. The first eNodeB 210 contains an antenna or an antenna array 302 or a plurality of antennae, coupled to a directional coupler or duplexer or antenna switch 304 (dependent upon the nature of the communications supported) that provides isolation between receive and transmit chains within the first eNodeB 210. One or more receiver chains, as known in the art, include(s) receiver front-end circuitry 310 (effectively providing reception, RF filtering 306 and intermediate or base-band frequency conversion 304). In some examples, the receiver front-end circuitry 310 may comprise a simple receiver as described in one example embodiment of FIG. 2. The receiver front-end circuitry 310 is coupled to one or more signal processing module(s) 292. The one or more receiver chain(s) is/are operably configured to receive data packet streams in a plurality of time frames. In accordance with some example embodiments, at least one receiver front-end circuitry 306 of the receiver chain(s) is tuned or tuneable to an adjacent site's downlink frequency. Signal quality determination logic 293, illustrated in this example as part of the one or more signal processing module(s) 292, is arranged to determine a signal quality of signals received from the adjacent bi-directional transmitter and/or a pure signal power measurement of signals received from the adjacent bi-directional transmitter, when the receiver is unable to receive and decode packets from the adjacent uncast transmitter.

A controller 314 maintains overall operational control of the first eNodeB 210. The controller 314 is also coupled to the receiver front-end circuitry 310 and the one or more signal processing module(s) 296 (generally realised by one or more digital signal processor(s) (DSPs)). The controller 314 is also coupled to one or more memory devices/elements 316 that selectively stores operating regimes, such as decoding/encoding functions, synchronisation patterns, code sequences, and the like. A timer 318 is operably coupled to the controller 314 to control a timing of operations (transmission or reception of time-dependent signals) within the first eNodeB 210.

As regards the transmit chain, this includes transmitter/modulation circuitry 322 and a power amplifier 324 operably coupled to the antenna or antenna array 302. The transmit chain is operably configured to transmit/broadcast data packet streams to a plurality of users/UEs (not shown). The transmitter/modulation circuitry 322 and the power amplifier 324 are operationally responsive to the controller 314 (and or the one or more signal processing module(s) 296). A directional coupler 344 is located at the output of the power amplifier 324 to couple off a portion of the broadcast transmit signal and provide the portion to a feedback circuit 330. In one example, the feedback circuit may be arranged to process the portion of the broadcast transmit signal, and/or control parameters of the transmit chain such as one or more amplifiers in transmitter/modulation circuitry 322 and/or the power amplifier 324, to influence the transmit power of the broadcast transmissions. In one example, the feedback circuit may be arranged solely to route, and not to process, the portion of the broadcast transmit signal, and/or control parameters of the transmit chain such as one or more amplifiers in transmitter/modulation circuitry 322 and/or the power amplifier 324, to influence the transmit power of the broadcast transmissions.

The one or more signal processor module(s) 292 in the transmit chain may be implemented as distinct from the one or more signal processor module(s) 292 in the receive chain. Alternatively, a single processor may be used to implement a processing of both transmit and receive signals, as shown in FIG. 3. Clearly, the various components within the wireless communication unit (e.g. first eNodeB 210) can be realized in discrete or integrated component form, with an ultimate structure therefore being an application-specific or design selection.

In accordance with example embodiments of the invention, the one or more signal processor module(s) 292 has/have been adapted to comprise signal quality determination logic 293 (encompass hardware, firmware and/or software) to determine whether there is a likelihood of interference in UL or DL channels with communications between the first eNodeB 210 and one or more second eNodeBs. In one example, the signal quality determination logic 293 may be located in feedback circuit 330. In one example, the signal quality determination logic 293 may determine whether a safe physical distance exists between the first and second eNodeBs, with regard to their network parameters, where the term ‘safe’ encompasses an acceptable one or more network parameters, such as at least one of: transmit power, receiver blocking performance, antenna azimuth, antenna tilt, polarisation of an antenna, transmission polarisation, etc. In a broadcast system, polarisation of an antenna or transmission polarisation may be adapted as antenna diversity is not required. In one example, such network parameters may encompass one or more threshold values whereby the signal quality determination logic 293 determines that communications may be deemed to be safe for the two eNodeBs to simultaneously co-exist without interference occurring if one, a plurality or all network parameters are at a suitable level above or below their respective threshold value(s).

Referring now to FIG. 4, a more detailed block diagram of one example of a wireless communication unit, such as first eNodeB 210, is illustrated. The first eNodeB 210 contains an antenna or an antenna array 302 or a plurality of antennae, coupled to antenna switch 304 that provides isolation between receive and transmit chains within the first eNodeB 210. The antenna switch 304 is operably coupled to receiver RF filter 306 via a receive/sense signal path 408. The receiver RF filter 306 is tuned or tuneable to an adjacent site's downlink frequency associated with the uplink channel at risk of interference. In this manner, the receiver RF filter 306 is tuned or tuneable to extract the adjacent site's transmit signal and predominantly filter out any other received signal. Signal quality determination logic 292, is arranged to determine a signal quality of signals received from the adjacent bi-directional transmitter and comprises, in this example, signal power measurement logic 293 arranged to provide a received signal strength indication (RSSI). In one example, the signal quality determination logic 292 calculates a coupling loss between the first eNodeB 210 and a second eNodeB 220 based on knowledge of adjacent system downlink transmit power.

In one example, the signal quality determination logic 293 may compare the signal power measurement to a threshold value in order to determine whether (or not) interference is likely/possible based on the broadcast transmit power and an adjacent system's known vulnerability to interference. The signal quality determination logic 293 provides a signal power indication to element manager and/or control logic 402. In one example, the element manager and/or control logic 402 may be configured to present the determined information to, say, a display (not shown). Alternatively, or in addition, the element manager and/or control logic 402 may be configured to provide the information to an alarm module (not shown) to raise an alarm, for example associated with the received signal power (or similar quality level) crossing a particular threshold level.

In one example, the element manager and/or control logic 402 is operably coupled to signal amplitude control logic 404, which may be arranged to set a signal level of the broadcast transmit signal in either digital signal generation logic 322 or in the amplifier chain of the transmitter, such as through control of the power amplifier line-up 324. A transmit RF filter 406 substantially filters out any unwanted transmit signals prior to routing the broadcast signal to the antenna 302 (or antenna array) via the antenna switch 304.

In one example, an integrated circuit may comprise for a first (broadcast) wireless network element at least one signal processor arranged to: receive (say via sense signal path 408) a downlink signal from a second (say, adjacent, bi-directional) wireless network element on a downlink channel associated with an uplink channel of the first (broadcast) wireless network element. The at least one signal processor may be arranged to, or comprise logic such as signal quality determination logic or power measurement logic to, determine therefrom a signal quality level of the downlink signal from the second wireless network element. The at least one signal processor may be arranged to, or comprise logic to, determine an interference potential between the first wireless network element and the second wireless network element from the signal quality determination; and adapt a network parameter of the first wireless network element in response to determining the interference potential.

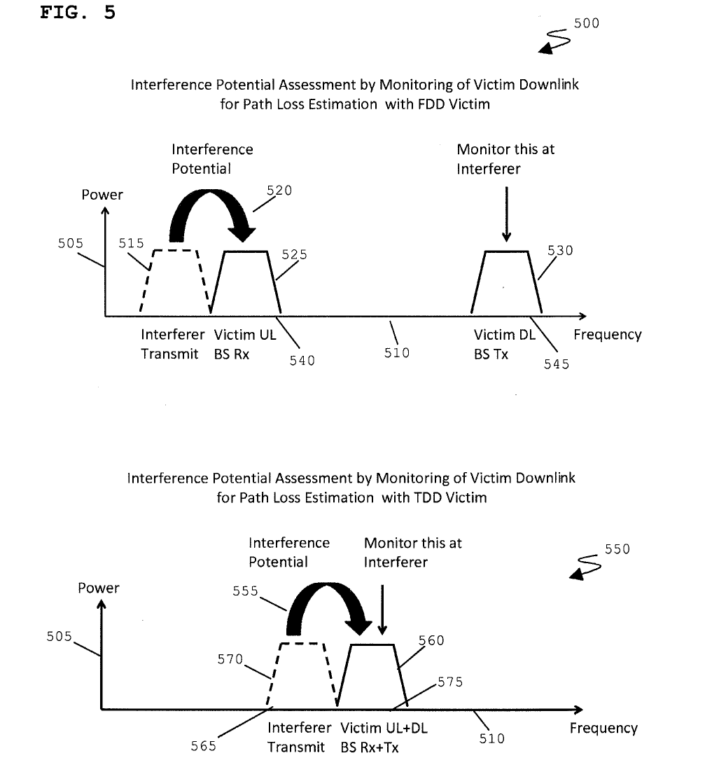

Referring now to FIG. 5, a pictorial representation 500 of interference potential on a FDD victim UL using a path loss estimation approach and a pictorial representation 550 of interference potential on a TDD victim UL for a path loss estimation are illustrated. The pictorial representations show power 505 vs. frequency 545, when there is a transmission, but may be regarded as attenuation (in contrast to power) in a case of UL receive operation. The pictorial representation of an FDD victim illustrates a transmit interference signal 515 that causes (potential) interference 520 on a victim UL NodeB receiver 540. The pictorial representation of a TDD victim illustrates a transmit interference signal 570 that causes interference (potential) 555 on a victim UL and DL NodeB transceiver 560.

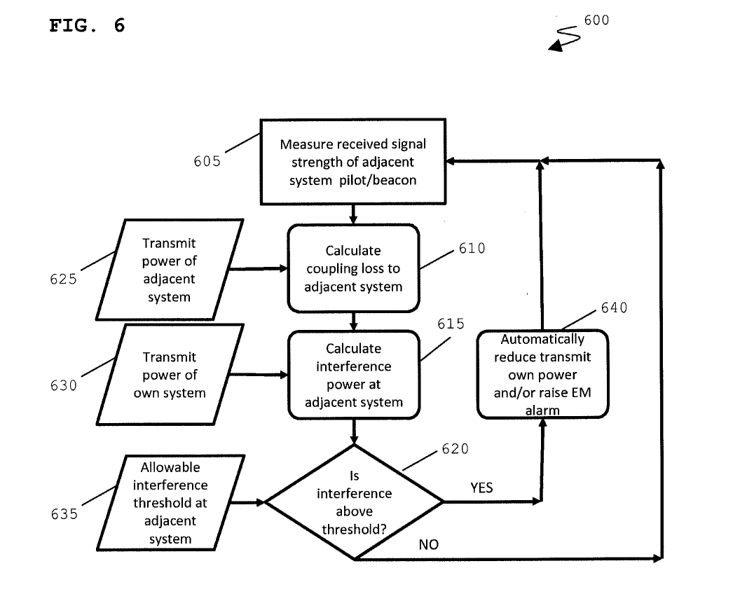

Referring now to FIG. 6, a flowchart 600 illustrates one example of a method for reducing interference between a first wireless network element operating in, for example, a first wireless communication system and a second wireless network element, operating in, for example a second wireless communication system. The flowchart 600 starts, at the first wireless network element (e.g. a broadcast eNodeB), with the first wireless network element performing a measurement of received signal strength (or similar signal quality indication) of a transmission from an adjacent network element, for example by measuring a received signal strength of the adjacent (bidirectional) eNodeB's pilot or beacon signal, as shown at 605. In some examples, other measurements of the transmission from the adjacent (bi-directional) eNodeB's may be performed, such as measuring a bit error rate, a block error rate, a frame error rate, a carrier-to-interference signal, a carrier-to-interference plus noise signal, etc. In other examples, a very sophisticated receiver may be configured to read system information in order to be able to determine what the original transmit power of a beacon signal was. In yet other examples, a manual input of one or more relevant parameters or values may be made to assist the coupling or path loss calculation.

The signal processing module of the first wireless network element may then calculate a coupling loss of signal power to the adjacent (bi-directional) eNodeB, as shown at 610. In order to perform such a calculation, the signal processing module receives, as an input, an indication of the transmit power of the adjacent system, as shown at 625.

The signal processing module of the first wireless network element may then calculate an interference power caused to the adjacent system by transmissions from the first wireless network element, as shown at 615. In order to perform such a calculation, the signal processing module receives, as an input, an indication of its own transmit power, as shown at 630. A determination is then made as to whether the calculated interference level is above a threshold level, as shown at 620. In order to perform such a determination, the signal processing module receives, as an input, an indication of an allowable level of interference of the adjacent system, as shown at 635.

If the determination at 620 is that the calculated interference level is above a threshold level, the first wireless network element automatically reduces its own transmit power level or it raises an element manager (EM) alarm, as shown at 640. The flowchart then loops back to the signal strength measurement at 605. If the determination at 620 is that the calculated interference level is not above a threshold level, the flowchart loops back to the signal strength measurement at 605.

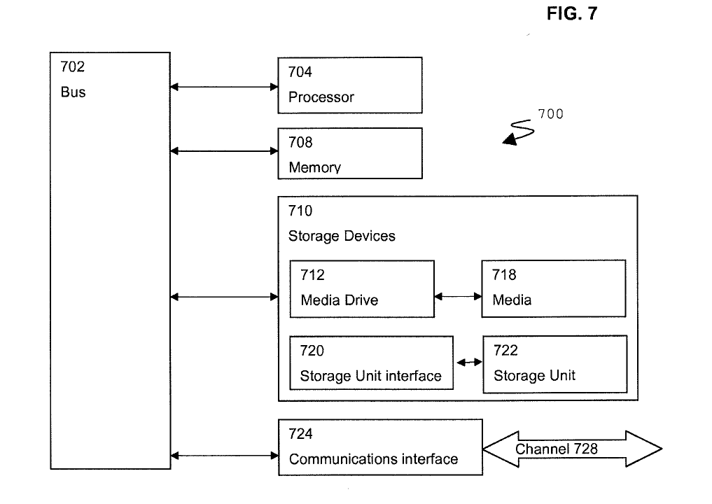

Referring now to FIG. 7, there is illustrated a typical computing system 700 that may be employed to implement software controlled interference reduction functionality in embodiments of the invention. Computing systems of this type may be used in wireless communication units, such as first or second wireless network elements. Those skilled in the relevant art will also recognize how to implement the invention using other computer systems or architectures. Computing system 700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special-purpose processing engine such as, for example, a microprocessor, microcontroller or other control logic. In this example, processor 704 is connected to a bus 702 or other communications medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 718 may include, for example, a hard disk, floppy disk, magnetic tape, optical disk, CD or DVD, or other fixed or removable medium that is read by and written to by media drive 712. As these examples illustrate, the storage media 718 may include a computer-readable storage medium having particular computer software or data stored therein.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a universal serial bus (USB) port), a PCMCIA slot and card, etc. Software and data transferred via communications interface 724 are in the form of signals which can be electronic, electromagnetic, and optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’, ‘computer-readable medium’ and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as ‘computer program code’ (which may be grouped in the form of computer programs or other groupings), when executed, enable the computing system 700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 722, drive 712 or communications interface 724. The control logic (in this example, software instructions or computer program code), when executed by the processor 704, causes the processor 704 to perform the functions of the invention as described herein.

In one example, a tangible non-transitory computer program product comprises executable program code for reducing interference between a first wireless network element and a second wireless network element in a wireless communication system, the executable program code operable for, when executed at the first wireless network element: receiving a downlink signal from the second wireless network element on a downlink channel associated with an uplink channel of the first wireless network element; determining a signal quality level of the downlink signal from the second wireless network element; determining an interference potential between the first wireless network element and the second wireless network element from the measurement; and adapting a network parameter of the first wireless network element in response to determining the interference potential.

It will be appreciated that, for clarity purposes, the above description has described embodiments of the invention with reference to different functional units and processors. However, it will be apparent that any suitable distribution of functionality between different functional units or processors, without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Those skilled in the art will recognize that the functional blocks and/or logic elements herein described may be implemented in an integrated circuit for incorporation into one or more of the communication units. One example of the integrated circuit that is suitable for a first wireless network element for reducing interference between the first wireless network element and a second wireless network element in a wireless communication system comprises at least one signal processor. The at least one signal processor may be arranged to determine a signal quality level of a downlink signal from the second wireless network element on a downlink channel associated with an uplink channel of the first wireless network element; determine an interference potential between the first wireless network element and the second wireless network element from the measurement; and adapt a network parameter of the first wireless network element in response to determining the interference potential.

Furthermore, it is intended that boundaries between logic blocks are merely illustrative and that alternative embodiments may merge logic blocks or circuit elements or impose an alternate composition of functionality upon various logic blocks or circuit elements. It is further intended that the architectures depicted herein are merely exemplary, and that in fact many other architectures can be implemented that achieve the same functionality. For example, for clarity, the signal processing module 296 of the first network element has been illustrated and described as a single processing module, whereas in other implementations it may comprise separate processing modules or logic blocks.

Although the present invention has been described in connection with some example embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second”, etc. do not preclude a plurality.

1.-17. (canceled)

18. A method performed by a mobile device, the method comprising:
receiving, by the mobile device from a second network element, a downlink signal on a downlink channel associated with an uplink channel of a first network element;
determining, by the mobile device, a signal quality level of the downlink signal;
determining, by the mobile device, an interference potential between the first network element and the second network element from the signal quality level; and
adapting, by the mobile device, a network parameter associated with the downlink channel in response to the determining the interference potential.

19. The method of claim 18 wherein determining the signal quality level comprises assessing the interference potential on a second channel that is different to a first channel of the first network element.

20. The method of claim 18 further comprising:
assessing, by the mobile device in response to determining that a transmit operation on a first channel causes interference, the interference potential on a second channel.

21. The method of claim 18 wherein determining the signal quality level further comprises:
performing, by the mobile device, a measurement on the downlink channel to determine a path loss value in relation to the uplink channel.

22. The method of claim 18 wherein determining the signal quality level further comprises:
measuring, by the mobile device, a signal strength of a downlink pilot or beacon signal from the second network element.

23. The method of claim 18 wherein the determining the interference potential further comprises:
calculating, by the mobile device, a coupling loss from the first network element to the second network element.

24. The method of claim 18 wherein the determining the interference potential further comprises:
calculating, by the mobile device, an interference power that would be provided to the second network element from a transmission from the first network element.

25. The method of claim 18 wherein the adapting the network parameter of the first network element is performed, by the mobile device, in response to determining whether or not the interference potential exceeds an interference threshold value.

26. The method of claim 18 wherein the first network element is a broadcast downlink network element and the second network element is a bi-directional network element.

27. A mobile device comprising:
circuitry configured to receive, from a second network element, a downlink signal on a downlink channel associated with an uplink channel of a first network element;
circuitry configured to determine a signal quality level of the downlink signal;
the circuitry further configured to determine an interference potential between the first network element and the second network element from the signal quality level; and
circuitry configured to adapt a network parameter associated with the downlink channel in response to the determining the interference potential.

28. The mobile device of claim 27 wherein the determination of the signal quality level comprises assessing the interference potential on a second channel that is different to a first channel of the first network element.

29. The mobile device of claim 27 further comprising:
circuitry configured to assess, in response to a determination that a transmit operation on a first channel causes interference, the interference potential on a second channel.

30. The mobile device of claim 27 wherein the determination of the signal quality level further comprises:
circuitry configured to perform a measurement on the downlink channel to determine a path loss value in relation to the uplink channel.

31. The mobile device of claim 27 wherein the determination of the signal quality level further comprises:
circuitry configured to measure a signal strength of a downlink pilot or beacon signal from the second network element.

32. The mobile device of claim 27 wherein the determination of the interference potential further comprises:
circuitry configured to calculate a coupling loss from the first network element to the second network element.

33. The mobile device of claim 27 wherein the determination of the interference potential further comprises:
circuitry configured to calculate an interference power that would be provided to the second network element from a transmission from the first network element.

34. The mobile device of claim 27 wherein the adaptation of the network parameter of the first network element is performed in response to determining whether or not the interference potential exceeds an interference threshold value.

35. The mobile device of claim 27 wherein the first network element is a broadcast downlink network element and the second network element is a bi-directional network element.
